(19) United States
(12) Patent Application Publication
(10) Pub. No.: US 2001/0046593 A1
(43) Pub. Date: Nov. 29, 2001

(54) Light weight wrap material and process for preparing same

(76) Inventors: William E. Leavy, Westfield, MA (US); Jonathan G. Long, Feeding Hills, MA (US)

Correspondence Address: HOLLAND & BONZAGNI, P.C., Longmeadow Professional Park, Suite 302, 171 Dwight Road, Longmeadow, MA, 01106-1700, US

(21) Appl. No.: 09/819,411

(22) Filed: Mar. 28, 2001

Related U.S. Application Data
(60) Provisional application No. 60/194,080, filed on Apr. 3, 2000.

(51) Int. Cl. B32B 15/08; B32B 3/00; B32B 7/00; B32B 15/00; B32B 15/04

(52) U.S. Cl. 428/198; 428/458; 428/461; 428/463; 428/334; 428/342; 428/209

(57) ABSTRACT

Lightweight and absorbent wrap materials that demonstrate superior vapor barrier, heat retention, and masking properties, and a process for preparing such materials, are provided. The lightweight and absorbent wrap materials have an optionally repeating pattern of indicia on at least one surface thereof.

This application claims the benefit of U.S. Provisional Patent Application Ser. No. 60/194,080, filed Apr. 3, 2000, which is fully incorporated herein by reference.

### FIELD OF THE INVENTION

The present invention generally relates to lightweight and absorbent wrap materials that demonstrate superior vapor barrier, heat retention, and masking properties. More specifically, it relates to lightweight and absorbent wrap materials having an optionally repeating pattern of indicia on at least one surface thereof and to a process for preparing such materials.

### BACKGROUND OF THE INVENTION

In our rapidly paced society, it has become increasingly desirable to rely upon “fast-food” restaurants, supermarkets, convenience stores, and the like, for pre-prepared hot food items. For obvious reasons, the appearance of the packaging and the taste, temperature, and appearance of any such hot food item at the time of consumption are of primary importance to both consumer and vendor.

Packaging plays an integral role in maintaining or preserving the integrity of hot food items during storage and transport. It is therefore not surprising that heightened performance requirements have been placed on these types of materials. For example, packaging materials used for hot food items that have a tendency to exude liquids (e.g., grease, oil) are required to not only control the liquid exudate but also to mask stains caused by these liquids. In addition, such packaging must retain heat from water vapor lost by the hot food item and capture or absorb condensed vapor.

Attempts have been made to achieve these performance requirements or objectives, some of which are used commercially and/or described in printed publications. Generally, these attempts include coated papers and multi-ply composite materials such as hot melt coated paper, foil/tissue paper laminates and coated paper/polymer/paper laminates.

As discussed below, these attempts do not fully address the problems presented by the storage and transport of hot food items because they fail to meet one or more of the above-referenced performance requirements or objectives. Further, process economics for prior art wrap materials that are required to display some form of graphic design are less than desirable where such wrap materials must be subjected to a secondary printing operation.

Hot melt coated papers allow water vapor and associated heat to escape and, as such, do not serve as effective vapor or heat barriers.

Foil/tissue paper laminates, which employ aluminum foil layers having thicknesses of greater than 6.25 micrometers (μm), lose their gas barrier properties when creased and may actually conduct heat away from the enclosed hot food item.

Coated paper/polymer/paper laminates are disclosed in U.S. Pat. No. 5,128,182 to Bunker et al. This reference discloses a composite integral wrap material that comprises: a first layer of absorbent material; a second layer of printable material; and a water vapor impermeable polymer layer inter-disposed between the first and second layers. At least one of the first and second layers is discontinuously bonded to a respective side of the polymer layer at spaced locations, so that at least one of the first and second layers forms air pockets with the polymer layer at locations between the bond locations. As set forth at Col. 4, lns 66 to 68, of Bunker et al., the air pockets serve to insulate the hot food item by improving heat retention by decreasing conductive heat transfer.

Due to its three-ply structure, the Bunker et al. composite is relatively thick, making it difficult to fold this material tightly around a food item. In addition, the stain masking ability of this composite wrap material does not match that demonstrated by foil/tissue paper laminates.

Moreover, the composite integral wrap material of Bunker et al. requires the use of a second layer of printable material that, while serving to provide a printable surface on which food vendors may identify and distinguish their products from those of other vendors, adds a further step to the manufacturing process and increases the overall cost of the resulting product.

It is therefore an object of the present invention to provide a lightweight wrap material that satisfies all of the above-identified performance requirements for packaging for hot food items while offering unique graphics and improved process economics.

It is a more particular object of the present invention to provide a lightweight wrap material that controls liquid exudate from hot food items, masks stains caused by these liquids, retains heat from water vapor lost by the food items and captures or absorbs condensed vapor.

It is a further object of the present invention to provide a lightweight wrap material that can display an unlimited number of graphic designs while offering good process economics by obviating the need for a secondary printing process.

It is yet a further object to provide a lightweight wrap material, the properties of which are maintained even when the wrap material is creased or otherwise damaged during handling or use.

It is still a further object of the present invention to provide a process for preparing such lightweight wrap materials.

### SUMMARY OF THE INVENTION

The present invention therefore provides a lightweight wrap material having an optionally repeating pattern of indicia on at least one surface thereof, which comprises:

an inner layer of absorbent material, which is discontinuously bonded to;

an intermediate barrier layer having an outer surface; and

a metal coating located on the outer surface of the intermediate barrier layer, which displays the optionally repeating pattern of indicia.

The present invention further provides a process for preparing the above-identified lightweight wrap material, wherein the process comprises:

directing a layer of absorbent material to a location between a first and a second nip roller rotating in opposite directions, wherein a surface of the first nip roller has two patterns of peripherally spaced protrusions located thereon, wherein a first pattern comprises a plurality of regularly-spaced protrusions in the form of dots or other small markings and wherein a second pattern comprises an optionally-repeating pattern of protrusions in the form of indica;

directing a layer of barrier material to a location between the first and the second nip rollers adjacent to one side of the layer of absorbent material;

discontinuously bonding the adjacent layers while marking an outer surface of the barrier material with the two patterns of protrusions by passing the layers between the first and second nip rollers while maintaining the surface temperature of the second nip roller at from about 15 to about 35° C.; and

metallizing the outer marked surface of the barrier layer so as to form a metal coating which displays the two patterns of the first nip roller.

The foregoing and other features and advantages of the present invention will become more apparent from the following description and accompanying drawings.

### BRIEF DESCRIPTION OF THE DRAWINGS

Particular features of the disclosed invention are illustrated by reference to the accompanying drawings in which:

FIG. 1 is a cross-sectional view of the lightweight wrap material of the present invention;

FIG. 2 is a schematic view of a pair of nip rollers used to discontinuously bond the inner layer and intermediate barrier layer of the inventive wrap material while marking an outer surface of the barrier layer;

FIG. 3 is a cross-sectional view of the bonded inner layer and marked intermediate barrier layer of the inventive wrap material; and

FIG. 4 is a perspective view of a top surface of one embodiment of the lightweight wrap material of the present invention.

### DETAILED DESCRIPTION OF THE PREFERRED EMBODIMENT

The wrap material of the present invention demonstrates superior vapor barrier, heat retention and masking properties. These properties are maintained even when the wrap material is creased or otherwise damaged during handling and use. The inventive wrap material also offers good quality graphic images and good process economics.

The inventive wrap material also benefits from being a lightweight material. Apart from the obvious benefits of reduced volume and weight, the wrap material of the present invention consumes less metal than foil/tissue paper laminates and is responsible for placing less material into the waste stream.

The wrap material of the present invention is useful in a variety of applications that include, but are not limited to, packaging for hot food items. For example, the inventive wrap materials may also be used for any application in which foil/tissue paper or foil/paper laminates are used (e.g., ice cream wrap, gum wrap, butcher wrap, laminated bags, food pouches, and gift wrap).

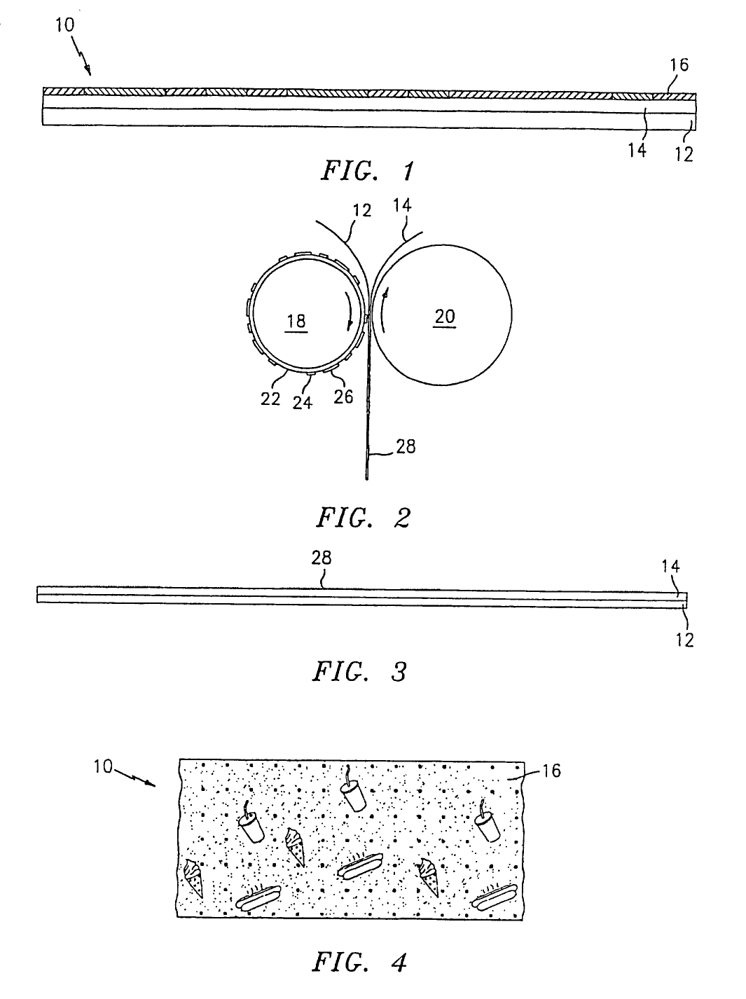

Referring to the drawings in detail, a preferred embodiment of the lightweight wrap material of the present invention is shown and generally designated by the reference numeral 10. As shown in FIG. 1, the invention basically comprises: an inner layer of absorbent material 12; an intermediate barrier layer 14; and an outer metal coating 16.

The inner layer of absorbent material 12 may be prepared from any material capable of absorbing fats or liquids. In a preferred embodiment, the absorbent material consists of fibers or fiber assemblies including cellulose pulp, rayon, selected synthetic fibers with hydrophilic surface treatments, and naturally occurring fibers. Such fibers are present in inner layer 12 in the form of tissue, creped tissue, paper or nonwoven sheets.

Optionally, inner layer 12 may contain a quantity of superabsorbent polymer in the form of granules, fibers or film.

In a preferred embodiment, the inner layer of absorbent material 12 is a tissue paper sheet that has a thickness ranging from about 35 to about 95 μm (most preferably from about 40 to about 65 μm) and a basis weight ranging from about 16 to about 65 grams per square meter (g/m²) (most preferably from about 24 to about 48 g/m²).

In another preferred embodiment, the inner layer of absorbent material 12 is a paper sheet that has a thickness ranging from about 50 to about 140 μm (most preferably from about 70 to about 105 μm) and a basis weight ranging from about 50 to about 165 g/m² (most preferably from about 67 to about 114 g/m²).

The intermediate barrier layer 14 of the present invention is an impermeable or semi-permeable sheet that serves to prevent the passage of water vapor and grease. Suitable materials for use in barrier layer 14 are thermoplastic homopolymers and copolymers that include ethylene acrylic acid copolymers, ethylene vinyl acetate, polyamides, polyolefins such as polyethylene and polypropylene, polyesters, polyisobutylene, polymethylpentene, polyvinylidene, hot melts and wax/polymer blends.

When the inventive lightweight wrap material 10 is used as a food wrap, intermediate barrier layer 14 facilitates heat retention within the package formed by the food wrap by acting as a condensation surface for water vapor released by the hot food item housed therein. Condensed water vapor is in turn absorbed by the inner layer of absorbent material 12 along with any grease or oils released by the food item.

In a preferred embodiment, the intermediate barrier layer 14 is polyethylene and has a thickness ranging from about 5 to about 40 μm (most preferably from about 10 to about 20 μm).

Inner layer 12 and intermediate layer 14 of lightweight wrap material 10 are discontinuously bonded to each other. In a preferred embodiment, bonded areas constitute greater than 8% of the total bondable surface area between layers 12, 14.

Layers 12, 14 are bonded so as to ensure that entrapment of air between these layers is minimized. The formation of air pockets between layers 12, 14 is viewed as disadvantageous where air pockets serve not only to increase the overall thickness of the wrap material, making it difficult to fold around a food item, but also contributes to the possible failure (e.g., rupture) of the barrier layer. As described in more detail below, two nip rollers are used to discontinuously bond layers 12, 14, with one such nip roller having patterns of peripherally spaced protrusions located on a surface thereof. The present inventors have discovered that by reducing the distance between adjacent protrusions on the nip roller or the speed at which the nip rollers rotate, air is allowed to escape during the bonding process, thereby minimizing the potential for air entrapment.

Although an absence of a plurality of air pockets between layers 12, 14 would immediately imply a reduction in the ability of the resulting wrap material to insulate hot food items by decreasing conductive heat transfer, the present inventors have found, instead, that superior heat retention properties are demonstrated by the wrap material 10 of the present invention.

In accordance with the practice of the present invention, discontinuous bonding of layers 12, 14 occurs simultaneously with the marking of an outer surface of layer 14. In a preferred embodiment, and as best shown in FIG. 2, inner layer 12 and intermediate layer 14 are discontinuously bonded, and an outer surface of layer 14 marked, by:

directing inner layer 12 to a location between a first and a second nip roller rotating in opposite directions 18, 20, wherein a surface 22 of the first nip roller 18 has two patterns of peripherally spaced protrusions 24, 26 located thereon, where a first pattern 24 comprises a plurality of regularly-spaced protrusions in the form of dots or other small markings and where a second pattern 26 comprises an optionally-repeating pattern of protrusions in the form of indicia;

directing intermediate barrier layer 14 to a location between the first and the second nip rollers 18, 20 adjacent to one side of inner layer 12, wherein intermediate barrier layer 14 is maintained at a temperature above its melt temperature; and

discontinuously bonding the adjacent layers 12, 14 while marking an outer surface 28 of the barrier layer 14 with the two patterns of protrusions 24, 26 by physically contacting inner layer 12 with the surface 22 of the first nip roller 18 at pressures ranging from about 3.9 to about 15.6 kilograms per linear centimeter (kg/linear cm) while passing these layers 12, 14 between the first and the second nip rollers 18, 20 and while maintaining the surface temperature of the second nip roller 20 at from about 15 to about 35° C.

As will be readily appreciated by those skilled in the art, the surface temperature of nip roller 20 is kept at a low temperature so that intermediate barrier layer 14 can cool and set upon contacting this surface. As will also be readily appreciated by those skilled in the art, while layer 14 is cooling and setting, the two patterns of protrusions 24, 26 of the first nip roller 18 are acting upon layers 12, 14 to discontinuously bond these layers and to mark the outer surface 28 of barrier layer 14.

As best shown in FIG. 3, the areas of the outer surface 28 of barrier layer 14 that are pressed against the surface of the second nip roller 20 by the two patterns of protrusions 24, 26 of the first nip roller 18 conform to the somewhat irregular or rough surface of roller 20. The areas of the outer surface 28 of barrier layer 14 that are not pressed against this irregular surface by protrusions 24, 26 adopt a smooth surface finish.

The first pattern of protrusions 24 on the first nip roller 18 are preferably in the form of dots that measure from about 0.4 to about 1.0 millimeters (mm) in diameter and from about 0.3 to about 0.8 mm in height and are preferably spaced less than or equal to 1.3 centimeters (cm) from adjacent dots. The second pattern of protrusions 26 on the first nip roller 18 may take the form of any optionally repeating pattern of indicia provided, however, that the bonded areas between layers 12, 14, which are formed by the first and second patterns of protrusions 24, 26, constitute greater than 8% of the total bondable surface area between layers 12, 14. The second pattern of protrusions 28 preferably measure from about 0.3 to about 0.8 mm in height.

Outer metal coating 16 of lightweight wrap material 10 is applied to or deposited on the outer marked surface 28 of intermediate layer 14. This layer may be prepared from any metal including aluminum, nickel, and silver, with the preferred metal being aluminum.

Contemplated metal deposition techniques for use with the present inventive method include sputtering, e.g., planar magnetron sputtering, electron beam or thermal evaporation/sublimation, and electrolytic chemical deposition in addition to organometallic vapor pyrolysis.

Sputtering is a physical vapor deposition process that is carried out in a vacuum chamber, in which ions of gas (e.g., argon), are accelerated across a difference in electrical potential with sufficient force to eject atoms from a target. The ejected atoms travel through a partial vacuum until they collide with a surface (e.g., plastic substrate) on which they can condense to form a coating.

In a preferred embodiment, the metal layer is deposited via sputtering or vacuum deposition on the marked surface 28 of intermediate layer 14 to a thickness of from about 100 to about 250 angstroms (Å). The present inventors have made the surprising discovery that metal layers present at such reduced thicknesses not only contribute to the good heat retention properties demonstrated by the lightweight wrap material 10 of the present invention but also serve as effective gas barriers even when creased or otherwise damaged during handling or use.

As best shown in FIGS. 1 and 4, the metal that is deposited onto the somewhat irregular or rough areas of the outer marked surface 28 of intermediate barrier layer 14 adopts a matte or dull surface finish, while the metal that is deposited onto the smooth areas adopts a glossy finish. In other words, a unique graphical display is formed by the glossy and matte areas of the metal deposited on surface 28 which obviates the need to apply a separate printable surface or layer to this lightweight wrap material for the purpose of printing or otherwise displaying messages or advertisements to consumers.

It is noted that when inner layer 12 is a tissue paper or paper sheet, the unique graphics formed by the glossy and matte surface finish areas formed on surface 28 are advantageously visible on an outer surface of inner layer 12.

The lightweight wrap material 10 of the present invention may contain additional layers or coatings that serve to, for example, alter surface friction, protect metal coating 16 from corrosion, and/or alter the absorbency properties of layer 12. Moreover, and although not required, additional patterns, designs, characters, and the like, may be directly or indirectly applied to, or printed onto, outer metal coating 16 for the purpose of augmenting or enhancing the optionally repeating pattern of indicia displayed by metal coating 16.

It should be understood by those skilled in the art that obvious modifications can be made without departing from the spirit of the invention. Accordingly, reference should be made primarily to the accompanying claims, rather than the foregoing specification, to determine the scope of the invention.

Having thus described the invention, what is claimed is:

1. A lightweight wrap material having an optionally repeating pattern of indicia on at least one surface thereof, which comprises:
an inner layer of absorbent material; which is discontinuously bonded to,
an intermediate barrier layer having an outer surface; and
a metal coating located on the outer surface of the intermediate barrier layer,
wherein the metal coating displays the optionally repeating pattern of indicia.

2. The lightweight wrap material of claim 1, wherein the absorbent material is capable of absorbing fats and liquids.

3. The lightweight wrap material of claim 2, wherein the absorbent material is prepared using natural or synthetic fibers, and wherein the fibers are optionally surface treated to render them hydrophilic.

4. The lightweight wrap material of claim 3, wherein the absorbent material is prepared using cellulose fibers.

5. The lightweight wrap material of claim 3, wherein the absorbent material is prepared using rayon fibers.

6. The lightweight wrap material of claim 2, wherein the absorbent material is prepared using superabsorbent polymers in the form of granules, fibers, or film.

7. The lightweight wrap material of claim 1, wherein the absorbent material is a tissue paper sheet having a thickness ranging from about 35 to about 95 micrometers, and a basis weight ranging from about 16 to about 65 grams per square meter.

8. The lightweight wrap material of claim 1, wherein the intermediate barrier layer is an impermeable or semi-permeable sheet which prevents passage of water vapor and grease.

9. The lightweight wrap material of claim 8, wherein the intermediate barrier layer is prepared using thermoplastic homopolymers and copolymers selected from the group consisting of ethylene acrylic acid copolymers, ethylene vinyl acetate, polyamides, polyolefins, polyesters, polyisobutylene, polymethylpentene, polyvinylidene, and mixtures thereof.

10. The lightweight wrap material of claim 9, wherein the intermediate barrier layer is prepared using polyolefins selected from the group consisting of polyethylene and polypropylene.

11. The lightweight wrap material of claim 10, wherein the polyolefin is polyethylene, and wherein the intermediate barrier layer has a thickness ranging from about 5 to about 40 micrometers.

12. The lightweight wrap material of claim 1, wherein bonded areas between the inner layer of absorbent material and the intermediate barrier layer constitute greater than 8% of the total bondable surface area between these layers.

13. The lightweight wrap material of claim 1, wherein the metal coating is comprised of a metal selected from the group consisting of aluminum, nickel, and silver.

14. The lightweight wrap material of claim 13, wherein the metal coating is an aluminum metal coating.

15. The lightweight wrap material of claim 14, wherein the aluminum metal coating has a thickness ranging from about 100 to about 250 angstroms.

16. A process for preparing a lightweight wrap material having an optionally repeating pattern of indicia on at least one surface thereof, wherein the process comprises:
directing a layer of absorbent material to a location between a first and a second nip roller rotating in opposite directions, wherein a surface of the first nip roller has two patterns of peripherally spaced protrusions located thereon, wherein a first pattern comprises a plurality of regularly-spaced protrusions in the form of dots or other small markings, and wherein a second pattern comprises an optionally-repeating pattern of protrusions in the form of indicia;
directing a layer of barrier material to a location between the first and the second nip rollers adjacent to one side of the layer of absorbent material;
discontinuously bonding the adjacent layers while marking an outer surface of the barrier material with the two patterns of protrusions by passing the layers between the first and the second nip rollers while maintaining the surface temperature of the second nip roller at from about 15 to about 35° C.; and
metallizing the outer marked surface of the intermediate barrier layer so as to form a metal coating which displays the two patterns of the first nip roller.

17. The process of claim 16, wherein the layer of barrier material is maintained at a temperature above its melt temperature while it is directed to a location between the first and the second nip rollers.

18. The process of claim 16, wherein the adjacent layers are discontinuously bonded and the outer surface of the barrier material is marked by physically contacting the inner layer with the surface of the first nip roller at pressures ranging from about 3.9 to about 15.6 kilograms per linear centimeter while passing these layers between the first and the second nip rollers.

19. The process of claim 16, wherein bonded areas between the layer of absorbent material and the layer of barrier material constitute greater than 8% of the total bondable surface area between these layers.

20. The process of claim 16, wherein the first pattern of protrusions on the first nip roller are in the form of dots, and wherein each dot has a diameter ranging from about 0.4 to about 1.0 millimeters, and a height ranging from about 0.3 to about 0.8 millimeters, and is spaced less than or equal to 1.3 centimeters from adjacent dots.

21. The process of claim 16, wherein each protrusion of the second pattern of protrusions has a height ranging from about 0.3 to about 0.8 millimeters.

22. The process of claim 16, wherein the metal coating has a thickness ranging from about 100 to about 250 angstroms.
